(19) United States
(12) Patent Application Publication
(10) Pub. No.: US 2014/0146710 A1
(43) Pub. Date: May 29, 2014

(54) Trill Network Communications Across an IP Network

(71) Applicant: Xiaopeng Yang, Haidian District (CN)

(72) Inventor: Xiaopeng Yang, Haidian District (CN)

(73) Assignee: Hangzhou H3C Technologies Co. Ltd., Hangzhou, Zhejiang (CN)

(21) Appl. No.: 14/232,906

(22) PCT Filed: Aug. 30, 2012
(86) PCT No.: PCT/CN2012/080771

§ 371 Date: Jan. 15, 2014

(30) Foreign Application Priority Data
Sep. 14, 2011 (CN) 201110272008.X

(51) Int. Cl. H04L 12/741; H04L 12/24

(52) U.S. Cl. CPC H04L 45/745; H04L 41/12
USPC 370/255

(57) ABSTRACT

A method, system and device of Transparent Interconnection of Lots of Links (TRILL) network communications across an Internet Protocol (IP) network are provided. The method includes: DC1 and DC2 which are respectively a local and remote Data Center (DC) networks connected with each other via the IP network; DC1 and DC2 are respectively deployed with a TRILL network; a first DCI device (S1, S2) is an RBridge located in core layer of TRILL network in DC1; a first access layer device (S10, S11, S20) is any RBridge located in access layer of TRILL network in DC1; a second DCI device (S1, S2) is an RBridge located in core layer of TRILL network of DC2; a second access layer device (S30, S31, S40) is an RBridge located in access layer of TRILL network in DC2; generating, by the first DCI device (S1, S2), a nickname forwarding table by learning routes to RBridges in local and remote TRILL networks, after receiving a packet destined for DC2 or sent by DC2, forwarding, by the first DCI device (S1, S2), the packet according to the nickname forwarding table.

### BACKGROUND

Transparent Interconnection of Lots of Links (TRILL) is a Layer-2 network technology set by Internet Engineering Task Force (IETF). TRILL is mainly applied in a data center network, and is used for solving issues that exist in a Spanning Tree Protocol (STP) network, such as an insufficient link issue, data streams that have been forwarded with a non-optimal path, and temporary emergence of loops.

Each device in a TRILL network supports TRILL functions, which also possesses switch functions and routing functions. These can be referred to as RBridges. Each RBridge in the TRILL network has a unique Nickname. The size of the Nickname is 16 bits. The Nickname may be automatically assigned by protocol.

### BRIEF DESCRIPTION OF DRAWINGS

The accompanying drawings illustrate various examples of the principles described herein and are a part of the specification. The examples do not limit the scope of the claims. As used herein, the term “includes” means includes but not limited to, the term “including” means including but not limited to. The term “based on” means based at least in part on. In addition, the terms “a” and “an” are intended to denote at least one of a particular element.

FIG. 1 is a diagram illustrating a TRILL network according to one example of principles described herein.

FIG. 2 is a diagram of an illustrative Nickname forwarding table generated by each RBridge in FIG. 1 according to one example of principles described herein

FIG. 3 is a diagram of illustrative Media Access Control (MAC) table generated by an RBridge in an access layer in FIG. 1, according to one example of principles described herein.

FIG. 4 is a flowchart of an illustrative method for forwarding a unicast packet in a TRILL network, according to one example of principles described herein.

FIG. 5 is a diagram of a TRILL network communication across an Internet Protocol (IP) network according to one example of principles described herein.

FIGS. 6 and 7 combine to form a flowchart describing a method for executing TRILL network communications across a network according to one example of principles described herein.

FIG. 8 is a diagram of a system structure according to one example of principles described herein.

Throughout the drawings, identical reference numbers designate similar, but not necessarily identical, elements.

### DETAILED DESCRIPTION

In the following description, for purposes of explanation, numerous specific details are set forth in order to provide a thorough understanding of the present systems and methods. It will be apparent, however, to one skilled in the art that the present apparatus, systems and methods may be practiced without these specific details. Reference in the specification to “an example” or similar language means that a particular feature, structure, or characteristic described in connection with the example is included in at least that one example, but not necessarily in other examples.

The disclosure relates to network communications technologies, and more particular, to a method, system and device of TRILL network communications across an IP network.

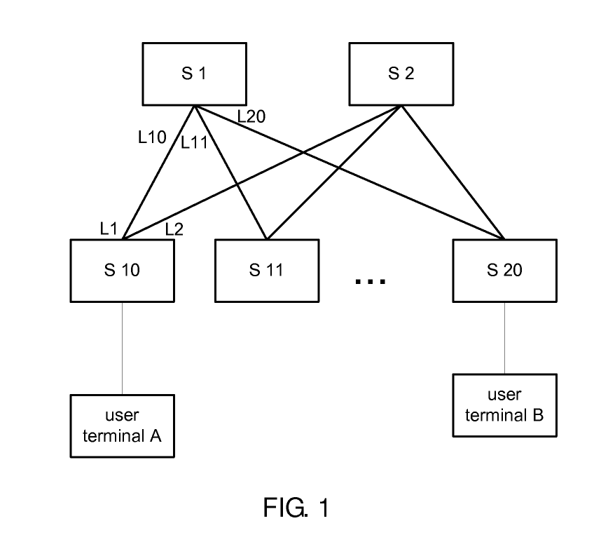

FIG. 1 is a diagram illustrating a TRILL network according to one example of principles described herein. In FIG. 1, each of S1˜S20 is an RBridge which has a unique nickname. Each of S10, S11, . . . S20 is an RBridge located in an access layer of the TRILL network and is used for connecting with user terminals. Each of S1 and S2 is an RBridge located in a core layer of the TRILL network in which the lower part thereof is connected with an RBridge of the access layer.

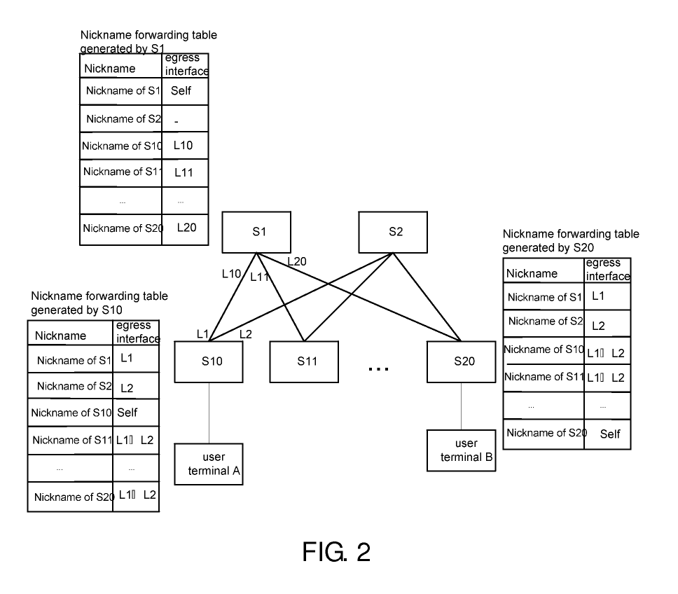

In the TRILL network shown in FIG. 1, each RBridge may obtain topology of the whole TRILL network by running a Layer2 Intermediate System to Intermediate System Routing Protocol (Layer2 IS-IS). Each RBridge may generate a Nickname forwarding table that defines how to reach other RBridges with a shortest path algorithm. The generated Nickname forwarding table includes a corresponding relationship between a nickname of a learned RBridge and an egress interface reaching the RBridge. FIG. 2 shows three Nickname forwarding tables respectively generated by S10, S1 and S20. Structure of a Nickname forwarding table generated by other RBridge may be similar.

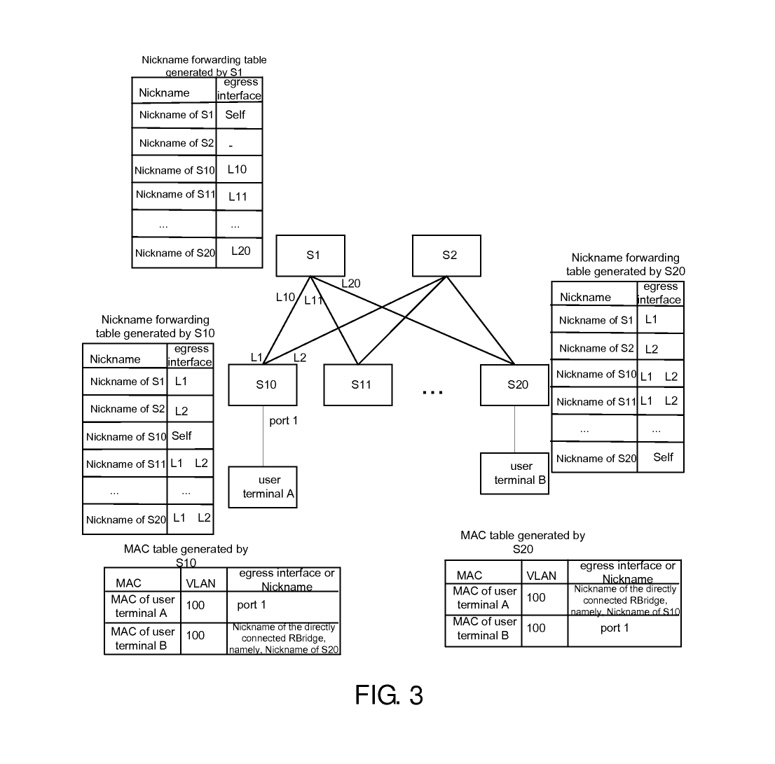

In FIG. 1, an RBridge located in access layer of the TRILL network may learn MAC addresses of directly connected terminals, according to MAC address learning mode of an Ethernet switch. Format of the learned MAC address may be as follows: MAC address+VLAN--->reach an egress interface of a directly connected terminal. With reference to a MAC address of an indirectly connected terminal, an RBridge located in the access layer of the TRILL network may learn the MAC address of the indirectly connected terminal via a data plane or a control plane. The format of learned MAC address is: MAC address+VLAN--->Nickname. The VLAN may denote a VLAN belonging to an interface of an RBridge directly connected with the MAC address. The Nickname may denote a Nickname of an RBridge directly connected with the MAC address. A MAC table may be established according to the above format using learned MAC addresses. An example of MAC table may be seen in FIG. 3. In the above examples, a unicast packet may be taken as an example of a packet that may be used in the forwarding process in a TRILL network.

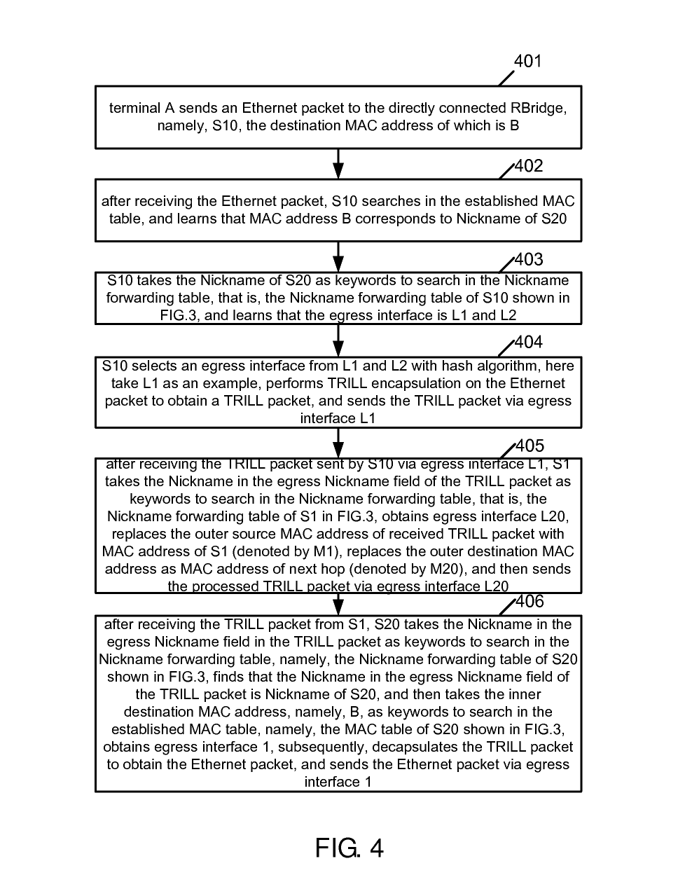

FIG. 4 is a flowchart of an illustrative method for forwarding a unicast packet in a TRILL network according to one example of principles described herein. In FIG. 4 terminal A sends an Ethernet packet to terminal B. The MAC address of terminal A is A. Similarly, the MAC address of terminal B is B. The forwarding process will now be described with reference to FIG. 4.

Block 401, terminal A sends an Ethernet packet, the destination MAC address of which is B, to an RBridge directly connected with terminal A. In this example, the RBridge directly connected with terminal A is, S10. The source MAC address of the Ethernet packet may be denoted by an inner source MAC address as A. The destination MAC address of the Ethernet packet may be denoted by an inner destination MAC address as B.

Block 402, after receiving the Ethernet packet, S10 searches in the established MAC address table and learns that MAC address B corresponds to the nickname of S20.

Block 403, S10 takes the Nickname of S20 as a keyword and search in the generated Nickname forwarding table, such as the Nickname forwarding table of S10 shown in FIG. 2. S10 may then get that the egress interfaces are L1 and L2.

Block 404, S10 may select an egress interface from egress interfaces L1 and L2 with a hash algorithm, take L1 as an example, and then performs TRILL encapsulation on the Ethernet packet. S10 may further send the packet processed with the TRILL encapsulation via egress interface L1.

The TRILL encapsulation process refers to adding a TRILL header and an outer Ethernet header to an Ethernet packet. The outer destination MAC address of the outer Ethernet header is the MAC address of the next hop such as the MAC address of S1 (denoted by M1). The outer source MAC address is the MAC address of S10 (denoted by M10). In the TRILL header, a ingress Nickname field is the Nickname of S10 while the egress Nickname field is the Nickname of S20.

Block 405, after receiving the TRILL packet sent by S10 via egress interface L1, S1 takes the Nickname in the egress Nickname field of the TRILL packet as the keyword to use in searching within the generated Nickname forwarding table, such as the Nickname forwarding table of S1 shown in FIG. 2, obtains the egress interface L20, replaces the outer source MAC address of the received TRILL packet with the MAC address of S1 (denoted by M1), replaces the outer destination MAC address of the received TRILL packet with the MAC address of next hop (denoted by M20), and then, sends the TRILL packet via egress interface L20.

Block 406, after receiving the TRILL packet sent by S1, S20 takes the Nickname in the egress Nickname field of the TRILL packet as the keyword used to search in the generated Nickname forwarding table, such as the Nickname forwarding table of S20 shown in FIG. 2 and finds that the Nickname in the egress Nickname field of the TRILL packet is the Nickname of S20. S20 then takes the inner destination MAC address (in this example B) as the keyword used to search in the established MAC table, (such as the MAC table of S20 shown in FIG. 3) and obtains egress interface 1. Subsequently, S20 decapsulates the TRILL packet and sends the Ethernet Packet obtained after decapsulating the TRILL packet via egress interface 1. Since terminal B connects to S20 via egress interface 1 of S20, terminal B may receive the Ethernet packet sent by S20. In this way, the unicast packet forwarding in the TRILL network may be accomplished.

Using this method, the unicast packet forwarding in the TRILL network is not limited in the local TRILL network. When the TRILL network is deployed within a Data Center Interconnection (DCI) to implement the core network of layer-2 networking, the two TRILL networks respectively in the two DC networks may be independent of each other. However, communications between a local TRILL network and a remote TRILL network can still be implemented.

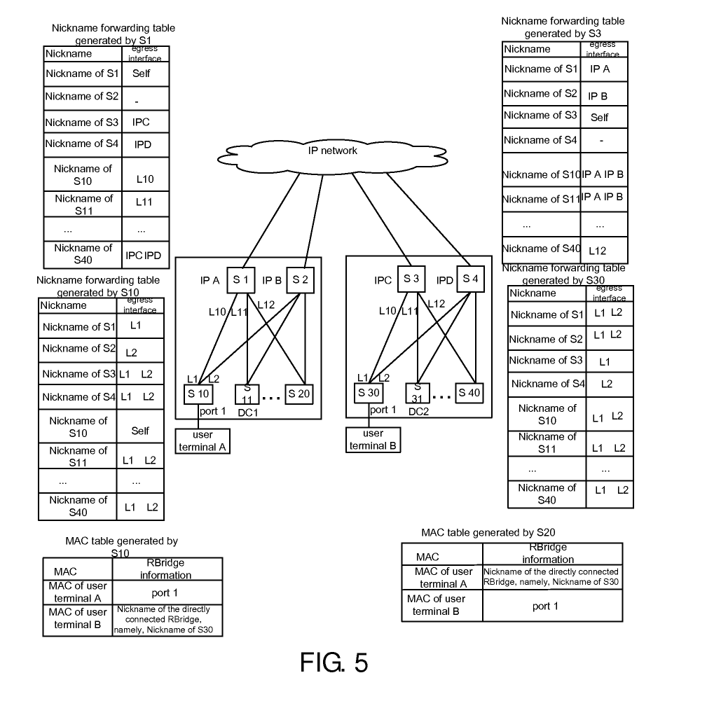

FIG. 5 is a diagram of a TRILL network communication across an IP network according to one example of principles described herein. As shown in FIG. 5, DC1 and DC2 are respectively a local DC network and a remote DC network, which connect to each other via an IP network. A TRILL network is respectively deployed in DC1 and DC2. RBridges (S1, S2) located in the core layer of the TRILL network of DC1 are taken as DCI devices of DC1 (denoted by first DCI devices), which connect to RBridges (S10, S11, . . . S20) located in access layer of the TRILL network of DC1. RBridges located in the access layer of the TRILL network of DC1 are denoted by a first access layer device. RBridges located in core layer of the TRILL network of DC2 (i.e. S3, S4) are taken as DCI devices of DC2 (denoted by a second DCI device). The second DCI device connects to RBridges located in the access layer of the TRILL network of DC2 (i.e., S30, S31, . . . S40). An RBridge located in access layer of the TRILL network of DC2 is denoted by a second access layer device. Generally, an RBridge may be located in the access layer of the TRILL network similar to the first access layer device. The second access layer device may connect with multiple user terminals.

In some examples, networking for TRILL network communications across an IP network may include more DC networks. A TRILL network may be deployed in each DC network included therein. Thus, the networking shown in FIG. 5 may be extended to include any number of DC networks and TRILL networks.

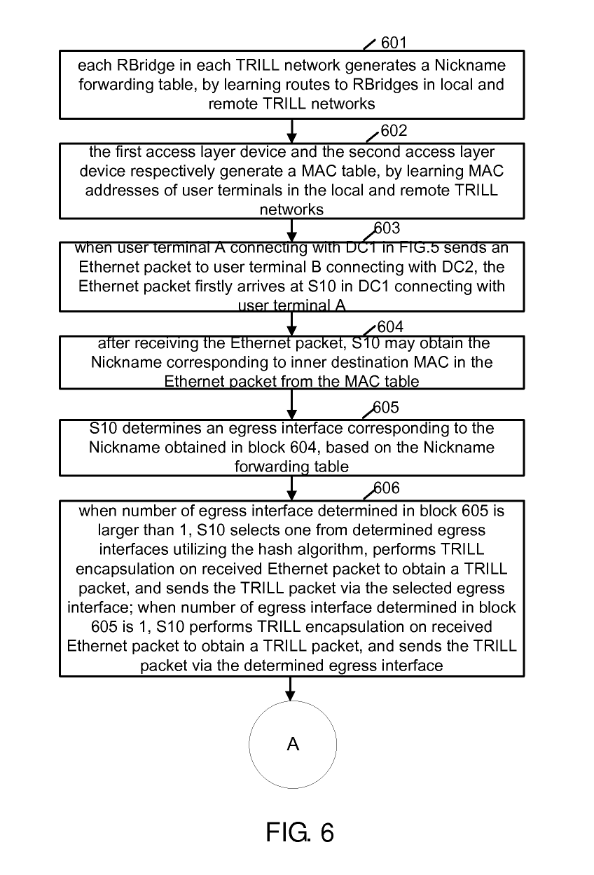

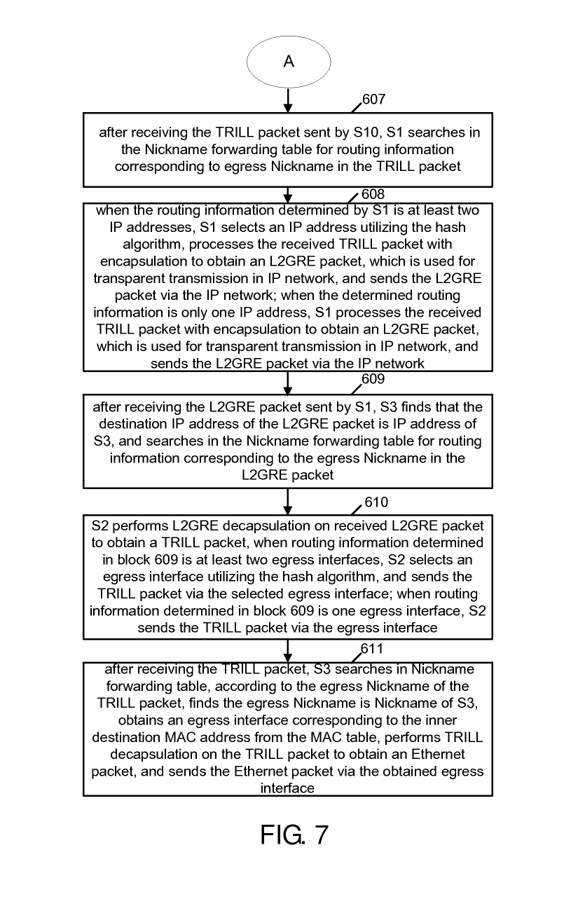

Based on the networking shown in FIG. 5, a method for executing TRILL network communications across an IP network will now be described with reference to FIGS. 6 and 7. FIGS. 6 and 7 combine to form a flowchart describing a method for executing TRILL network communications across an IP network according to one example of principles described herein. The method described in FIGS. 6 and 7 is based on the networking shown in FIG. 5.

The method may begin with each RBridge in each TRILL network generating a Nickname forwarding table and learning routes to RBridges in local and remote TRILL networks. In this example, when two TRILL networks are connected with each other, a different Nickname may be assigned for each RBridge in the TRILL network to ensure that the Nickname of each RBridge is unique in the whole network.

Additionally, an RBridge may obtain the topology of the whole network by running Layer2 IS-IS. As a result, the RBridge may more easily learn the RBridges in the local and remote TRILL networks by using the obtained network topology structure. The RBridge may learn a route to an RBridge in the local TRILL network by utilizing an existing mode of learning the route to an RBridge in the local TRILL network. Regarding route to an RBridge in the remote TRILL network, since the local TRILL network is connected to the remote TRILL network via an IP network, the RBridge may learn a route to another RBridge in the remote TRILL network by utilizing a shortest path algorithm and a routing table learned via a routing protocol. Looking at FIG. 5 as an example, it may be learned that the TRILL networks of DC1 and DC2 in FIG. 5 are in different locations utilizing the Layer2 IS-IS.

Therefore, each of the first DCI devices, (i.e. S1, S2 in FIG. 5) the second DCI devices, (i.e. S3 and S4 in FIG. 5), the first access layer device (i.e. S10 to S20 in FIG. 5), and the second access layer devices (i.e. S30 to S40), may generate a corresponding Nickname forwarding table. Format of the Nickname forwarding table generated by a DCI device is different from that generated by an access layer device, as will be described later.

When an RBridge is the first DCI device, or the second DCI device, (i.e. S1 in FIG. 5), the principles for generating the Nickname forwarding table of other DCI devices are similar. The Nickname forwarding table generated by S1 includes a corresponding relationship between both a Nickname of an RBridge learned by S1 and the routing information to the RBridge. When the learned RBridge is in the local TRILL network, that is, when the learned RBridge and S1 are located within the same TRILL network, (i.e. the learned RBridge of S10, S11 in FIG. 5) then routing information to the RBridge is the egress interface from S1 to the RBridge.

When the learned RBridge is located in a remote network, that is, the learned RBridge and S1 are located in different TRILL networks, then the routing information to the RBridge is IP address of next hop to the RBridge. Since S1 is located in DC1 and the learned RBridge is located in DC2 (i.e. S3 and S30 located in DC2) then the routing information to the RBridge is IP address of next hop to the RBridge. Here, the IP address of next hop is the IP address of the second DCI device. FIG. 5 illustrates the Nickname forwarding tables respectively generated by S1 and S3.

When the RBridge is the first or second access layer device, (i.e. S10 in FIG. 5), the principle for generating the Nickname forwarding table of another access layer device is similar. The Nickname forwarding table generated by S10 may include a corresponding relationship between both a Nickname of an RBridge learned by S10 and an egress interface from S10 to the RBridge. FIG. 5 illustrates a number of Nickname forwarding tables generated by S10 and S30, however, other Nickname forwarding tables may exist according to the description above.

After, each RBridge in each TRILL network generates (block 601) a Nickname forwarding table by learning routes to RBridge in local and remote TRILL networks, the first and second access layer devices may respectively generate (602) a MAC table by learning MAC addresses of the user terminals in the local and remote TRILL networks. In one example, the first and second access layer devices may learn (block 602) MAC addresses of the user terminals in the local and remote TRILL networks with a data plane. The MAC table may at least include a corresponding relationship between the MAC address and information about an RBridge directly connected with a user terminal of the MAC address. When the MAC address is a MAC address of a user terminal in the local TRILL network, the RBridge information corresponding to the MAC address is an egress interface destined for the user terminal having the MAC address started from an RBridge directly connected with the user terminal having the MAC address. When the MAC address is a MAC address of a user terminal in a remote TRILL network, the RBridge information corresponding to the MAC address is Nickname of an RBridge directly connected with the user terminal having the MAC address. FIG. 5 illustrates the MAC tables generated by access layer devices S10 and S30. These tables are presented as examples and the format of a MAC table generated by other access layer devices may be produced in a similar fashion.

In one example, the method described in block 601 and 602 may be performed by beginning the process with the method described in block 601 followed by the method described in 602. In another example, the method described in block 601 and 602 may be performed by beginning the process with the method described in block 602 followed by the method described in block 601.

Block 603, when user terminal A connected with DC1 in FIG. 5 sends a packet to user terminal B connected with DC2, the packet firstly arrives at S10 connected with user terminal A in DC1. In block 603, the inner destination MAC address included in the packet sent by user terminal A is MAC address of user terminal B, the inner source MAC address therein is the source MAC address of user terminal A.

Block 604, after receiving the packet, S10 may obtain the Nickname corresponding to the inner destination MAC address of the packet from the MAC table. When user terminal A sends a packet to user terminal B (block 604) the inner destination MAC address is MAC address of user terminal B. User terminal B connects with DC2, which is a remote TRILL network compared with a local TRILL network DC1 located by S10. Based on foregoing descriptions about the MAC table, it can be seen that in the MAC table generated by S10, the MAC address of user terminal B corresponds to the Nickname of an RBridge directly connected with user terminal B. That is, S10 may search in the MAC table generated by S10 shown in FIG. 5 for the MAC address of user terminal B, and obtain the Nickname corresponding to the MAC address of user terminal B.

Block 605, S10 may determine an egress interface corresponding to the Nickname obtained in block 604, based on the generated Nickname forwarding table. For example, if the Nickname determined in block 604 is the Nickname of S30, in block 605, S10 may search in the Nickname forwarding table generated by S10 shown in FIG. 5 for the Nickname of S30, and obtain the egress interface corresponding to the Nickname.

In block 606, when the number of the egress interface determined in block 605 is larger than 1, S10 may select one egress interface with the hash algorithm, encapsulate the received packet into a TRILL packet, and send the TRILL packet via the selected egress interface. When the number of egress interface determined in block 605 is 1, S10 may encapsulate the received packet into a TRILL packet and send the TRILL packet via the determined egress interface.

Based on the Nickname forwarding table generated by S10 in FIG. 5, it can be seen that when searching in the Nickname forwarding table generated by S10 in block 605 for the Nickname of S30, two egress interfaces corresponding to the Nickname may be obtained: L1 and L2 respectively. Subsequently, in block 606, S10 may select one egress interface with the hash algorithm. There may be various modes when using the hash algorithm during specific implementations, e.g., select an interface with a larger sequence number or select an interface with a smaller sequence number, which are not limited in the example.

Besides, in block 606, an outer MAC address header and TRILL header are encapsulated into the TRILL packet. In the outer MAC address header, the outer destination MAC address is the MAC address of the next hop, and the outer source MAC address is the MAC address of the sender of the TRILL packet. Regarding the TRILL header, the RBridge directly connected with user terminal B (i.e. S30) of the ingress Nickname in the TRILL header is the Nickname of S10.

In one example, the S10 may send a packet via the L1 interface. After receiving the TRILL packet sent by S10, S1 may search in the generated Nickname forwarding table for routing information corresponding to the egress Nickname of the TRILL packet.

Based on foregoing descriptions, the egress Nickname of the TRILL packet is the Nickname of S30. However, based on FIG. 5, it can be seen that S1 and S30 are located in different sites. Thus, in the Nickname forwarding table generated by S1, the routing information corresponding to the Nickname of S30 is the IP address of the next hop destined for S30 from S1.

In block 608, when the routing information determined by S1 is at least two IP addresses, one IP address according to the hash algorithm, S1 processes the received TRILL packet with an IP encapsulation used for transparent transmission in an IP network, and S1 send the TRILL packet with the IP encapsulation via the IP network. When the determined routing information comprises one IP address, S1 processes the received TRILL packet with the IP encapsulation used for transparent transmission in the IP network, and sends the TRILL packet with the IP encapsulation via the IP network.

In one example, the IP encapsulation used for transparent transmission in the IP network may be L2GRE encapsulation. Other similar encapsulations may be used. The use of the L2GRE encapsulation is taken as an example only, and in the following description is used for illustrative purposes.

Based on the Nickname forwarding table generated by S1 shown in FIG. 5, it can be seen that the routing information corresponding to the Nickname of S30 determined in block 607 comprises the IP addresses of the next two hops. In this examples, these are respectively the IP address of S3 taken as the DCI device in DC2 (i.e. IP C) and the IP address of S4 taken as the DCI device in DC2 (i.e. IP D). Thus, in block 608, S1 may select one IP address of the next hop according to the hash algorithm.

From description above regarding the method descried in block 608, it can be seen that traffic sharing of multiple DCI devices may be implemented in the example by using multi-path loading sharing capability of the TRILL network. That is, multi-homing capability of a DCI may be implemented.

Besides, in block 608, by performing the IP encapsulation on a TRILL packet, such as L2GRE encapsulation, at least source IP address (i.e. IP address of S1) and destination IP address (i.e. the IP address of the next hop) may be added to the TRILL packet.

Additionally, while performing the process described in block 608, the outer destination MAC address and outer source MAC address of the received TRILL packet may be replaced. That is, the outer destination MAC address may be replaced with the MAC address of the next hop and the outer source MAC address may be replaced with the MAC address of S1.

After receiving the L2GRE packet sent by S1, S3 may find (block 609) that the destination IP address in the L2GRE packet is the IP address of itself, and S3 may search in the Nickname forwarding table for the routing information corresponding to the egress Nickname in the L2GRE packet. Since the egress Nickname is the Nickname of S30, S30 and S3 are located in the same TRILL network. Consequently, the routing information corresponding to the egress Nickname searched out by S3 is an egress interface destined for S30 from S3.

Block 610, S3 then performs a L2GRE decapsulation on the L2GRE packet received, selects an egress interface utilizing the hash algorithm. When the routing information determined in block 609 is at least two egress interfaces, S3 sends the TRILL packet obtained after decapsulating the L2GRE packet via the selected egress interface. When the routing information determined in block 609 is one egress interface, S3 sends the TRILL packet via the egress interface.

Based on the Nickname forwarding table generated by S3 shown in FIG. 5, it can be seen that the routing information corresponding to the Nickname of S30 (determined in block 609) comprises one egress interface (i.e. L10). Thus, in block 610, S3 may send the TRILL packet via the determined egress interface (i.e. L10).

Additionally, while performing the process described in block 610, the outer destination MAC address, and outer source MAC address of the received TRILL packet may be replaced. That is, the outer destination MAC address may be replaced with the MAC address of the next hop and the outer source MAC address may be replaced with the MAC address of S3.

Block 611, after receiving the TRILL packet, S30 may search in the Nickname forwarding table and, according to the egress Nickname in the TRILL packet, find that the egress Nickname is itself. S30 may further obtain the egress interface corresponding to the inner destination MAC address from the MAC table, perform TRILL decapsulation and send the Ethernet packet via the obtained egress interface.

In this example, the inner destination MAC address is the MAC address of user terminal B. The user terminal B locates in the same TRILL network with S30. Thus, in the MAC table of S30, the MAC address of user terminal B corresponds to an egress interface of the RBridge directly connected with user terminal B. Consequently, S30 may search in the MAC table of S30 shown in FIG. 5 for the MAC address of user terminal B, and obtain the egress interface corresponding to the MAC address of user terminal B (i.e. port 1). S30 may then send the packet processed with TRILL decapsulation via port 1. In this way, user terminal B may receive the packet. Thus, interconnection and intercommunication between the two TRILL networks of the present example may be implemented.

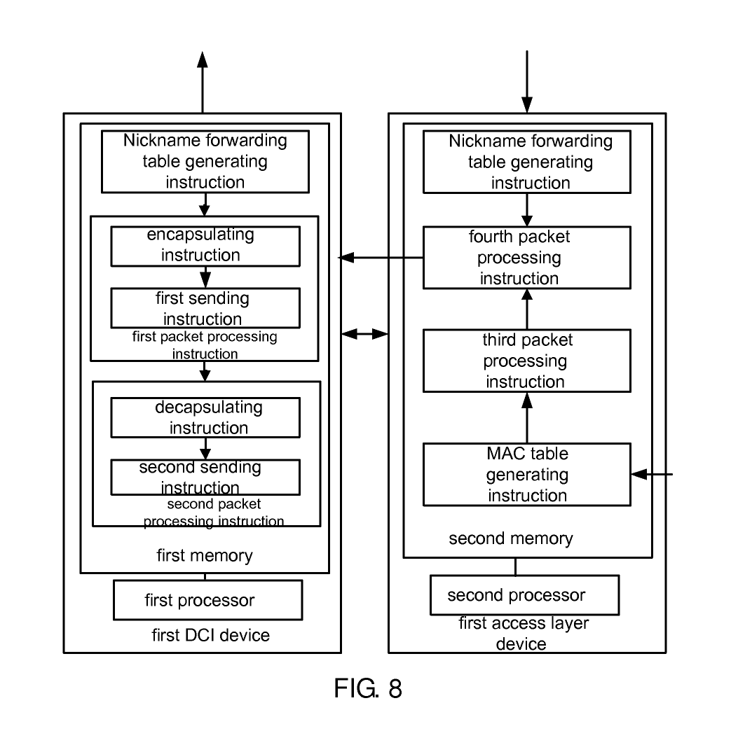

FIG. 8 is a diagram of a system structure according to one example of principles described herein. As shown in FIG. 8, the system includes a first DCI device and a first access layer device.

The first DCI device is located in DC1. DC1 connects with DC network DC2 via an IP network. Each of DC1 and DC2 is deployed with a TRILL network. The first DCI device is an RBridge located in core layer of TRILL network of DC1.

The first access layer device, which connects with the first DCI device, is any RBridge located in access layer of TRILL network of DC1. The first access layer device is used for sending a TRILL packet to the first DCI device.

A description of the first access layer device and the first DCI device will now be provided. The first DCI device may include a first memory, and a first processor in communication with the first memory. The first memory may store a first set of operation instructions executable by the first processor. The first set of operation instructions further include a Nickname forwarding table generating instruction and a packet processing instruction.

The Nickname forwarding table generating instructions, when executed by a processor, generate a Nickname forwarding table by learning routes to RBridges in local and remote TRILL networks. The nickname forwarding table includes a corresponding relationship between both the Nickname of a learned RBridge and routing information to the RBridge. When the learned RBridge is in the local TRILL network, the routing information to the RBridge is the egress interface destined for the RBridge. When the learned RBridge is in a remote TRILL network, the routing information to the RBridge is IP address of the next hop destined for the RBridge.

The packet processing instructions, when executed by a processor, search for the received packet after being forwarded according to the Nickname forwarding table.

The packet processing instructions further include a first packet processing instruction and a second packet processing instruction (not shown in the figure). The first packet processing instructions, when executed by a processor, receive a TRILL packet sent by the first access layer device, in which the egress Nickname of the TRILL packet is the Nickname of the second access layer device, searches in the Nickname forwarding table for the IP address of next hop corresponding to the egress nickname, and takes the IP address of next hop as destination IP address to be encapsulated into the L2GRE packet. The first packet processing instructions, when executed by a processor, further causes the L2GRE packet to be sent to the destination IP address via an IP network. The second access layer device may be any RBridge located in access layer of the TRILL network in DC2.

The second packet processing instructions, when executed by a processor, causes a L2GRE packet to be received from DC2, in which the egress Nickname of the L2GRE packet is the nickname of the first access layer device. The second packet processing instructions, when executed by a processor, further determines whether the destination IP address encapsulated in the L2GRE packet is IP address of itself. If yes, the second packet processing instructions, when executed by a processor, causes a search to be performed in Nickname forwarding table for the egress interface corresponding to the egress Nickname in the L2GRE packet and further causes the TRILL packet, which is obtained after decapsulating the L2GRE packet, to be sent via the egress interface.

As shown in FIG. 8, the first access layer device includes a second memory, and a second processor in communication with the second memory. The second memory stores a second set of operation instructions executable by a second processor. The second set of operation instructions further includes Nickname forwarding table generating instructions, MAC table generating instructions, third packet processing instructions, and fourth packet processing instructions.

The Nickname forwarding table generating instructions, when executed by a processor, generates a Nickname forwarding table, by learning routes to RBridges in the local and remote TRILL networks. The Nickname forwarding table includes a corresponding relationship between both the Nickname of a learned RBridge and an egress interface destined for the RBridge.

The MAC table generating instructions, when executed by a processor, generates a MAC table by learning MAC addresses. The MAC table at least includes a corresponding relationship between both the learned MAC address and the Nickname of the RBridge directly connected with the MAC address.

The third packet processing instructions, when executed by a processor, causes an Ethernet packet sent by user terminal A to be received by user terminal B in DC2, in which the Ethernet packet includes an inner destination MAC address, namely, MAC address of user terminal B. The third packet processing instructions, when executed by a processor, may further determine a nickname corresponding to the inner destination MAC address of the Ethernet packet according to the MAC table.

The fourth packet processing instruction, when executed by a processor, determines an egress interface corresponding to the determined Nickname, according to Nickname forwarding table; encapsulates the Ethernet packet into a TRILL packet; and, causes the TRILL packet to be sent to the first DCI device via the determined egress interface. The TRILL packet includes a egress Nickname, which is the Nickname of the second access layer device directly connected with user terminal B.

As shown in FIG. 8, the first packet processing instruction includes the following. Encapsulating instructions, when executed by a processor, causes an IP address to be selected when number of determined IP address of next hop is larger than 1. The encapsulating instructions, when executed by a processor, further processes the TRILL packet with an IP encapsulation used for transparent transmission in the IP network. When the number of determined IP address of the next hop is 1, the encapsulating instructions, when executed by a processor, may perform the IP encapsulation on the received TRILL packet. The IP encapsulation at least includes an L2GRE encapsulation. The following descriptions are provided, in which the IP encapsulation refers to the L2GRE encapsulation. And then, an L2GRE packet may be obtained by processing the TRILL packet with the IP encapsulation. The L2GRE packet includes a destination IP address, which is the IP address of the next hop of the TRILL packet.

A first sending instruction, when executed by a processor, may cause the L2GRE packet to be sent to the destination IP address via the IP network. The L2GRE packet received from DC2 according to the second packet processing instructions is obtained after processing a TRILL packet with the IP encapsulation, that is, the L2GRE encapsulation, which may comprise the following. Decapsulating instructions, when executed by a processor, may cause a decapsulation to be performed corresponding to the L2GRE encapsulation on the received L2GRE packet, so as to obtain a TRILL packet. Second sending instructions, when executed by a processor, may cause an egress interface to be selected when the number of determined egress interfaces is larger than 1. Second sending instructions, when executed by a processor, may cause the TRILL packet to be sent via the selected egress interface. When number of determined egress interface is 1, the second sending instructions cause the TRILL packet to be sent via the determined egress interface.

From the description above, it can be seen that a Nickname forwarding table may be generated by enabling the first DCI device to learn routes to RBridges in local and remote TRILL networks. When receiving a TRILL packet to be encapsulated into an L2GRE packet and destined for DC2, or receiving an L2GRE packet sent by DC2, the L2GRE packet may be forwarded utilizing the Nickname forwarding table. Thus, interconnection and intercommunication between local and remote TRILL networks may be implemented. Additionally, the DCI devices of DC1 and DC2 in the disclosure, which are respectively the first and second DCI devices, no longer need to learn a large number of MAC addresses of user side. Thus, the load of DCI devices may be reduced.

Furthermore, in the disclosure, an RBridge in the core layer of TRILL network of DC1 may be taken as the DCI device of DC1, namely, the first DCI device. An RBridge in the core layer of TRILL network of DC2 may be taken as the DCI device of DC2, namely, the second DCI device. Consequently, functions of an RBridge in core layer of TRILL network may be integrated into the DCI device, and the cost to construction the network may be reduced.

While the first DCI device and the first access layer device have been described, by way of example, as having a memory storing machine readable instructions and a processor to execute said instructions. However, the same result could be achieved by having the functions implemented at a hardware level, e.g. in an ASIC, or a combination of instructions read by a processor and functions implemented by an ASIC or other logic circuitry. All of these variations are within the scope of the present disclosure. Thus where the claims make reference to a processor causing certain operations to take place, it is to be understood that the ‘processor’ may be a processor executing machine readable instructions stored in a memory, or the processor may be a processor of an ASIC or the like, or a combination thereof.

What is claimed is:

1. A method of Transparent Interconnection of Lots of Links (TRILL) network communications across an Internet Protocol (IP) network, in which:
a first Data Center (DC1) and a second Data Center (DC2) are respectively a local and remote Data Center (DC) networks connected with each other via the IP network;
DC1 and DC2 are respectively deployed with a TRILL network,
a first Data Center Interconnection (DCI) device is an RBridge located in a core layer in DC1;
a first access layer device is any RBridge located in an access layer of DC1 that connects with the first DCI device;
a second DCI device is an RBridge located in a core layer in DC2, and
a second access layer device is an RBridge located in an access layer in DC2 that connects with the second DCI device;
the method comprising:
generating, by the first DCI device, a Nickname forwarding table by learning routes to RBridges in the local and remote DC networks,
wherein the Nickname forwarding table comprises a relationship between a Nickname of a learned RBridge and routing information to the RBridge:
when the learned RBridge is in the local DC network, the routing information to the RBridge is an egress interface destined for the RBridge, and
when the learned RBridge is in the remote DC network, the routing information to the RBridge is an IP address of the next hop destined for the RBridge; and
searching, by the first DCI device, in the Nickname forwarding table for a packet received.

2. The method according to claim 1, wherein searching by the first DCI device in the Nickname forwarding table for the packet received comprises:
receiving, by the first DCI device, a TRILL packet sent by the first access layer device, wherein egress Nickname of the TRILL packet is Nickname of the second access layer device,
searching in the Nickname forwarding table for an IP address of the next hop corresponding to the egress Nickname;
taking the IP address of the next hop as a destination IP address to be encapsulated into an L2GRE packet;
sending the encapsulated L2GRE packet to the destination IP address via the IP network;
receiving, by the first DCI device, an L2GRE packet from DC2, wherein the egress Nickname of the L2GRE packet is Nickname of the first access layer device, determining whether the destination IP address encapsulated in the L2GRE packet is IP address of the first DCI device, in which
if the destination IP address encapsulated in the L2GRE packet is IP address of the first DCI device, the first DCI device:
searching in the Nickname forwarding table for an egress interface corresponding to the egress Nickname in the L2GRE packet; and
sending a TRILL packet obtained after decapsulating the L2GRE packet via the egress interface.

3. The method according to claim 1, further comprising:
generating, by the first access layer device, a Nickname forwarding table by learning routes to RBridges in the local and remote DC networks, wherein the Nickname forwarding table comprises a corresponding relationship between both a Nickname of a learned RBridge and an egress interface destined for the RBridge;
generating, by the first access layer device, a MAC table by learning the MAC addresses, wherein the MAC table comprises a corresponding relationship between both a learned MAC address and the Nickname of the RBridge directly connected with the MAC address;
wherein sending the TRILL packet to the first DCI device by the first access layer device comprises:
receiving, by the first access layer device, an Ethernet packet sent by a first user terminal connected with the first access layer device destined for a second user terminal in DC2, wherein the Ethernet packet comprises an inner destination MAC address, namely, the MAC address of the second user terminal, and
determining a Nickname corresponding to the inner destination MAC address of the Ethernet packet based on the MAC table;
searching, by the first access layer device, in the Nickname forwarding table for an egress interface corresponding to the determined Nickname, encapsulating the Ethernet packet into a TRILL packet, wherein the TRILL packet comprises an egress Nickname, namely, the Nickname of the second access layer device directly connected with the second user terminal; and
sending the TRILL packet to the first DCI device via the determined egress interface.

4. The method according to claim 3, wherein the first DCI device and the first access layer device learn routes to the RBridges in the local and remote DC networks by running Layer2 Intermediate System to Intermediate System Routing Protocol (Layer2 IS-IS) and using a shortest path algorithm.

5. The method according to claim 2, wherein taking the IP address of the next hop as the destination IP address to be encapsulated into the L2GRE packet and sending the L2GRE packet to the destination IP address via the IP network comprises:
when the number of determined IP addresses of the next hop is larger than 1, selecting an IP address;
processing the TRILL packet with an IP encapsulation used for transparent transmission in the IP network, wherein the IP encapsulation comprises an L2GRE encapsulation; and
when the number of determined IP addresses of the next hop is 1,
processing the received TRILL packet with the L2GRE encapsulation;
sending the L2GRE packet obtained after processing the received TRILL packet with the L2GRE encapsulation to the destination IP address via the IP network;
wherein the L2GRE packet comprises a destination IP address that is the IP address of the next hop of the TRILL packet.

6. The method according to claim 2, wherein when the first DCI device receives the L2GRE packet obtained after processing the TRILL packet with the L2GRE encapsulation from DC2, and, in which sending the L2GRE packet via the egress interface comprises:
performing an L2GRE decapsulation corresponding to the L2GRE encapsulation on the received L2GRE packet, and
obtaining the TRILL packet after processing the L2GRE packet with the L2GRE decapsulation; in which:
when the number of determined egress interfaces is larger than 1,
an egress interface is selected, and
the TRILL packet is sent via the selected egress interface; and
when number of determined egress interface is 1,
the TRILL packet is sent via the determined egress interface.

7. The method according to claim 6, further comprising:
generating, by the first access layer device, the Nickname forwarding table by learning routes to the RBridges in the local and remote DC networks, wherein the Nickname forwarding table comprises a corresponding relationship between both a Nickname of a learned RBridge and an egress interface destined for the RBridge;
generating, by the first access layer device, the MAC table by learning MAC addresses, wherein the MAC table comprises a corresponding relationship between both a learned MAC address and the Nickname of the RBridge directly connected with the MAC address; and
after receiving the TRILL packet, which is sent by the first DCI device, searching, by the first access layer device, in the Nickname forwarding table according to the egress Nickname of the TRILL packet;
determining whether the egress Nickname is the Nickname of the first access layer device; and
if the egress nickname is the nickname of the first access layer device, obtaining the egress interface corresponding to the inner destination MAC address in the TRILL packet from the MAC table, performing a TRILL decapsulation on the TRILL packet to obtain an Ethernet packet, and sending the Ethernet packet via the obtained egress interface.

8. The method according to claim 1, wherein the Nickname of each of the first DCI device, the second DCI device, the first access layer device and the second access layer device is unique in the TRILL networks deployed in DC1 and DC2.

9. A system of Transparent Interconnection of Lots of Links (TRILL) network communications across an Internet Protocol (IP) network, comprising:
a first Data Center Interconnection (DCI) device and a first access layer device;
wherein the first DCI device is located in a first Data Center (DC1);
DC1 and a second Data Center (DC2) are respectively a local and remote Data Center (DC) networks connected with each other via the IP network;
DC1 and DC2 are respectively deployed with a TRILL network,
the first DCI device is an RBridge located in a core layer of the TRILL network of DC1;
the first access layer device which is connected with the first DCI device is any RBridge in an access layer of the TRILL network of DC1 and is to send a TRILL packet to the first DCI device;
the first DCI device comprises a memory storing a Nickname forwarding table and a first processor to: generate a Nickname forwarding table by learning routes to RBridges in local and remote DC networks;
said Nickname forwarding table comprising a relationship between a Nickname of a learned RBridge and routing information to the RBridge;
when the learned RBridge is in the local DC network, the routing information to the RBridge is an egress interface to the RBridge;
when the learned RBridge is in the remote DC network, the routing information to the RBridge is an IP address of a next hop to the RBridge;
said first processor further to search for a received packet according to the Nickname forwarding table.

10. The system according to claim 9, wherein the first processor is to:—
receive the TRILL packet sent by the first access layer device, in which the egress Nickname of the TRILL packet is the Nickname of the second access layer device
search in the Nickname forwarding table for the IP address of the next hop corresponding to the egress Nickname,
take the IP address of the next hop as the destination IP address to be encapsulated into an L2GRE packet,
send an L2GRE packet obtained after processing the TRILL packet with the L2GRE encapsulation to the destination IP address via the IP network, in which the second access layer device is any RBridge in the access layer of the TRILL network of DC2;
and
receive an L2GRE packet from DC2, in which the egress Nickname of the L2GRE packet is the Nickname of the first access layer device, determine whether the destination IP address encapsulated in the L2GRE packet is IP address of itself; in which
if the destination IP address encapsulated in the L2GRE packet is IP address of itself, cause a search in the Nickname forwarding table for the egress interface corresponding to the egress Nickname in the L2GRE packet and send a TRILL packet obtained after decapsulating the L2GRE packet via the egress interface.

11. The system according to claim 9, wherein the first access layer device comprises a second processor to: generate the Nickname forwarding table by learning routes to RBridges in the local and remote DC networks; said Nickname forwarding table comprises a relationship between both a Nickname of a learned RBridge and the egress interface to the RBridge;
and wherein said second processor is further to generate a MAC table by learning MAC addresses;
wherein the MAC table comprises a relationship between a learned MAC address and the Nickname of the RBridge directly connected with the MAC address;
cause the first access layer device to receive an Ethernet packet sent by a first user terminal connected with the first access layer device to a second user terminal in DC2, in which, the packet comprises an inner destination MAC address, namely, the MAC address of the second user terminal; and determine the Nickname corresponding to the inner destination MAC address of the Ethernet packet from the MAC table;
to search in the Nickname forwarding table for an egress interface corresponding to the determined Nickname and encapsulate the packet into the TRILL packet;
wherein the TRILL packet comprises an egress Nickname, which is the Nickname of the second access layer device directly connected with the second user terminal, send the TRILL packet to the first DCI device via the determined egress interface.

12. The system according to claim 9, wherein the Nickname of each of the first DCI device, the first access layer device and the second access layer device is unique in the TRILL networks deployed in DC1 and DC2.

13. A Data Center Interconnection (DCI) device, wherein the DCI device is located in a first Data Center (DC1);
DC1 is connected with a second Data Center (DC2) via an Internet Protocol (IP) network;
DC1 and DC2 are respectively a local and remote DC network that are respectively deployed with a Transparent Interconnection of Lots of Links (TRILL) network;
the DCI device is an RBridge located in a core layer of the TRILL network in DC1, the DCI device is connected with a first access layer device, the first access layer device is any RBridge located in an access layer of the TRILL network in DC1;
the DCI device has a processor to: generate a Nickname forwarding table by learning routes to RBridges in the local and remote DC networks, wherein the Nickname forwarding table comprises a relationship between a Nickname of a learned RBridge and routing information to the RBridge, when the learned RBridge is in the local DC network, the routing information to the RBridge is an egress interface to the RBridge; and when the learned RBridge is in the remote DC network, the routing information to the RBridge is an IP address of the next hop to the RBridge;
and wherein the processor is to:
search for a received packet according to the Nickname forwarding table.

14. The DCI device according to claim 13, wherein the processor is to:
receive the TRILL packet sent by the first access layer device (S10, S11, S20), in which the egress Nickname of the TRILL packet is Nickname of the second access layer device,
search in the Nickname forwarding table for an IP address of next hop corresponding to the egress Nickname;
take the IP address of the next hop as destination IP address to be encapsulated into an L2GRE packet;
send the L2GRE packet to the destination IP address via the IP network, in which the second access layer device is any RBridge located in access layer of the TRILL network in DC2; and
receive the L2GRE packet from DC2, in which egress Nickname of the L2GRE packet is Nickname of the first access layer device, determine whether the destination IP address encapsulated into the L2GRE packet is IP address of itself;
if the destination IP address encapsulated into the L2GRE packet is IP address of itself, then search in the Nickname forwarding table for an egress interface corresponding to the egress Nickname in the L2GRE packet, and send the TRILL packet obtained after decapsulating the L2GRE packet via the egress interface.

15. The DCI device according to claim 13, wherein the processor is to:
select an IP address when number of determined IP addresses of the next hop is larger than 1,
process the TRILL packet with an IP encapsulation used for transparent transmission in the IP network, the IP encapsulation comprises an L2GRE encapsulation; and
when the number of determined IP address of the next hop is 1:
process the received TRILL packet with the L2GRE encapsulation to obtain an L2GRE packet;
in which the L2GRE packet comprises a destination IP address, in which the destination IP address is an IP address of the next hop of the TRILL packet, and
and wherein the processor is further to send the L2GRE packet to the destination IP address via the IP network;
receive the L2GRE packet;
process the received L2GRE packet with an L2GRE decapsulation corresponding to the L2GRE encapsulation and obtain a TRILL packet after processing the L2GRE packet with the L2GRE decapsulation; and
select an egress interface, when number of determined egress interface is larger than 1 and send the TRILL packet via the selected egress interface; and
when number of determined egress interface is 1, send the TRILL packet via the determined egress interface.
